(19) United States
(12) Patent Application Publication
(10) Pub. No.: US 2023/0367599 A1
(43) Pub. Date: Nov. 16, 2023

(54) Vector Gather with a Narrow Datapath

(71) Applicant: SiFive, Inc., San Mateo, CA (US)

(72) Inventors: Andrew Waterman, Berkeley, CA (US); Krste Asanovic, Oakland, CA (US)

(21) Appl. No.: 18/141,466

(22) Filed: Apr. 30, 2023

Related U.S. Application Data
(60) Provisional application No. 63/341,679, filed on May 13, 2022.

(51) Int. Cl. G06F 9/30

(52) U.S. Cl. CPC G06F 9/30141; G06F 9/30094

(57) ABSTRACT

Systems and methods are disclosed for vector gather with a narrow datapath. For example, some methods may include reading b bits of a vector of indices into a first operand buffer; reading b bits of the vector of source data into a second operand buffer, including an element indexed by a first index stored in the first operand buffer; checking whether other indices stored in the first operand buffer point to elements of the vector of source data stored in the second operand buffer; during a single clock cycle, copying a plurality of elements stored in the second operand buffer that are pointed to by indices stored in the first operand buffer to a third operand buffer; and updating flags in a completion flags buffer corresponding to those indices to indicate that handling of those indices has completed.

### CROSS-REFERENCE TO RELATED APPLICATION(S)

This application claims priority to and the benefit of U.S. Provisional Patent Application Ser. No. 63/341,679, filed May 13, 2022, the entire disclosure of which is hereby incorporated by reference.

### TECHNICAL FIELD

This disclosure relates to vector gather with a narrow datapath.

### BACKGROUND

Processors may be configured to execute vector register gather instructions that read elements from a from a first source vector register group at locations given by a second source vector register group. The index values in the second vector may be treated as unsigned integers. The source can be read at any index less than a maximum vector length. For example, the RISC-V instruction set architecture's vector extension includes a vector gather instruction with the following syntax:

vrgather.vv vd, vs2, vs1, vm #vd[i]=(vs1[i]>=VLMAX) ? 0: vs2[vs1[i]];

where vm is a mask register.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an integrated circuit for executing instructions including vector gather with a narrow datapath.

FIG. 2 is a block diagram of an example of an integrated circuit for executing instructions including vector gather with a narrow datapath and dynamic small vector detection to improve performance for small vectors.

FIG. 3 is a block diagram of an example of an integrated circuit for executing instructions including vector gather with a narrow datapath and dynamic small vector detection to improve performance for small vectors.

FIG. 4 is a flow chart of an example of a technique for vector gather with a narrow datapath.

FIG. 5 is a flow chart of an example of a technique for tracking completion of indices that are outside a valid range.

FIG. 6 is a flow chart of an example of a technique for tracking completion of indices for a masked vector gather instruction.

FIG. 7 is a flow chart of an example of a technique for simplifying vector gather completion when a variable vector length is small.

FIG. 8 is a flow chart of an example of a technique for outputting data of a vector gather instruction to a destination register.

FIG. 9 is a flow chart of an example of a technique for vector gather with a narrow datapath and variable vector length.

FIG. 10 is block diagram of an example of a system for facilitating generation and manufacture of integrated circuits.

FIG. 11 is block diagram of an example of a system for facilitating generation of integrated circuits.

### DETAILED DESCRIPTION

### Overview

Disclosed herein are implementations of vector gather with a narrow datapath. Some implementations may be used to exploit proximity of indexed elements of a vector to reduce execution time and perform gather instructions in a processor (e.g., CPUs such as x86, ARM, and/or RISC-V CPUs) more efficiently than previously known solutions.

Vector gather instructions may be challenging to implement at high performance in a temporal vector processor (i.e., a processor configured to process a vector over time, rather than all at once). A temporal vector processor may not have all of the operands available simultaneously for executing an instruction. This may make it difficult to gather more than one element per cycle, because the indices being processed may refer to data elements that are not physically near each other, thus requiring multiple register-file accesses.

Some implementations described herein opportunistically gather multiple elements per cycle when nearby indices happen to access elements that are nearby each other. For example, suppose a machine processes W elements at a time. Begin by reading W indices from the register file. We maintain a list of which W indices have been processed. The first unprocessed index may be picked, suppose its value is V. From the register file, read the W naturally aligned data elements surrounding V (i.e., the data elements numbered floor(V/W)*W through (floor(V/W)+1)*W−1. Now, scan the list of unprocessed indices. For each index that falls within the afore mentioned range [floor(V/W)*W through (floor(V/W)+1)*W−1], select the appropriate data element from among the W data elements we read, write the result back to the register file, and remove this index from the list of unprocessed indices. This process may be repeated until all W indices have been processed. If the vector length is greater than W, the above may be repeated until the entire vector has been processed.

In some implementations, where vector lengths in a vector register file are variable, small vectors may be detected to exploit simplifications resulting when an entire vector fits through a port of a datapath in the processor in a single clock cycle and can be held simultaneously in an operand buffer of an execution unit. The simplification may arise from a guarantee that all valid indices in a vector of indices input to a vector gather instruction with point to an element of source data present in an input operand buffer storing the source data vector. In the small vector case, all indices of the vector gather instruction may be executed in a single clock cycle and written back to the vector register file together. In implementations that track completion of the indices, as described above, this may obviate the need to track completion of indices and enable commensurate power savings. For example, small vectors may be detected by checking one or more configuration parameters stored in one or more control status registers of a processor core. Detecting small vector cases may also enable faster chaining in and/or chaining out of a vector gather instruction.

Implementations, described herein may provide advantages over conventional processors, such as, for example, reducing power consumption and/or improving performance of the processor core.

As used herein, the term “circuitry” refers to an arrangement of electronic components (e.g., transistors, resistors, capacitors, and/or inductors) that is structured to implement one or more functions. For example, a circuitry may include one or more transistors interconnected to form logic gates that collectively implement a logical function.

### Details

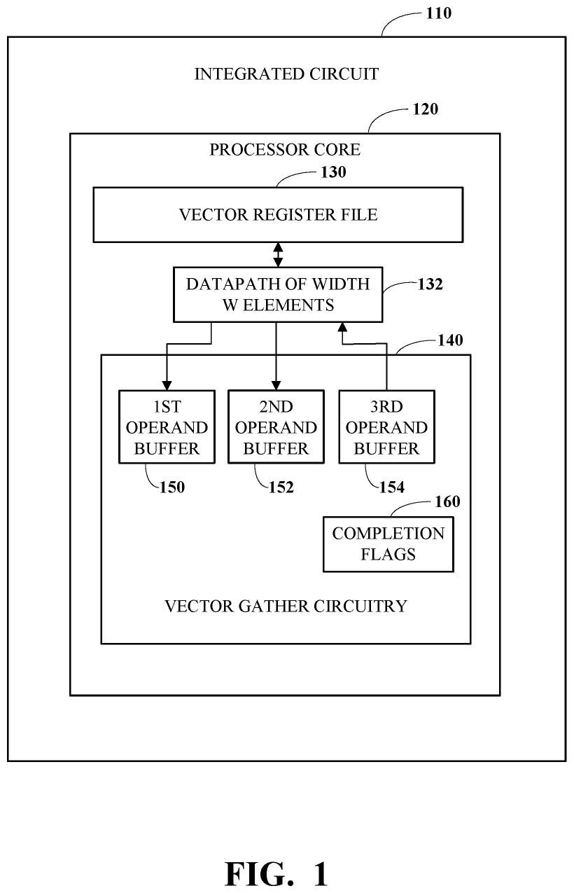

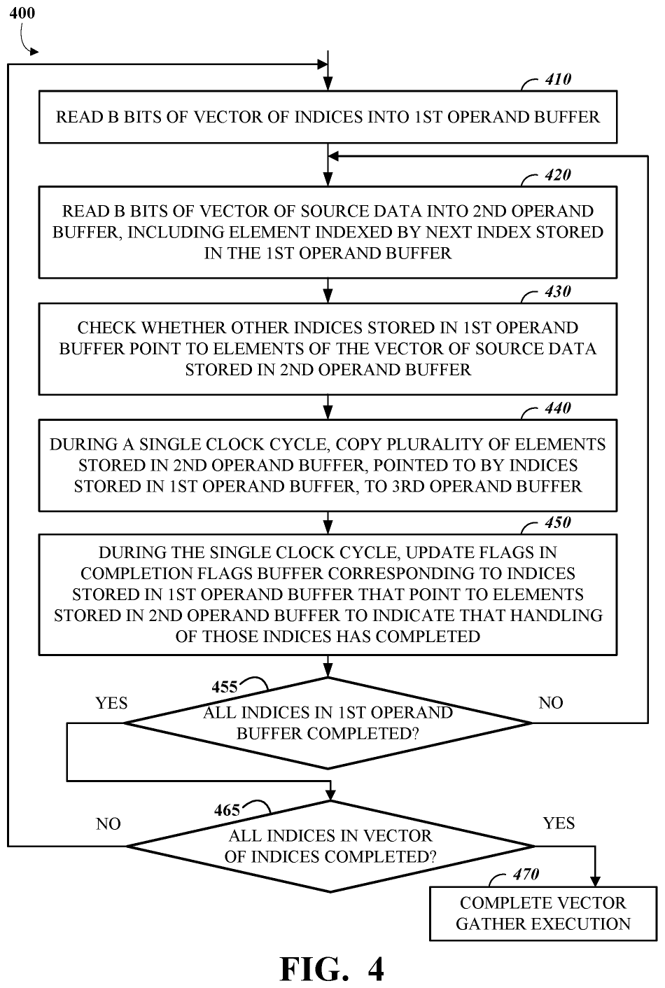

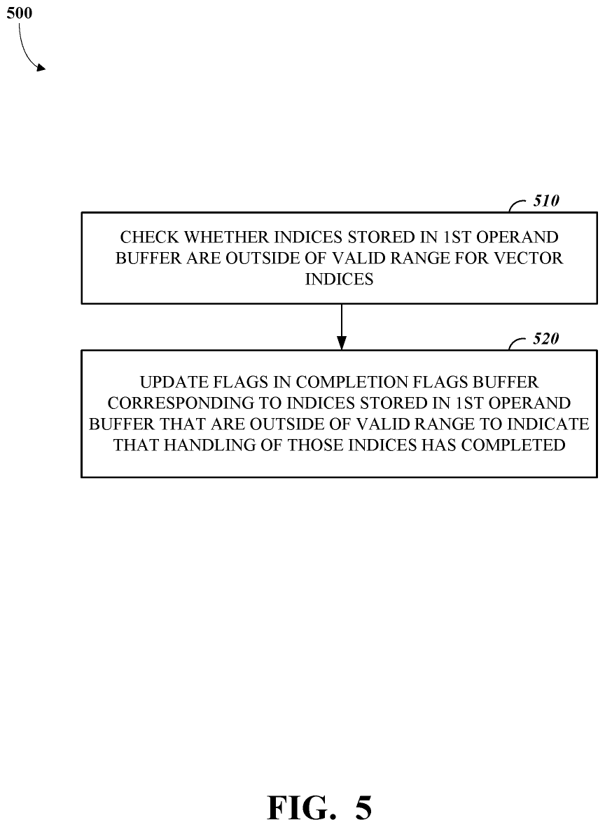

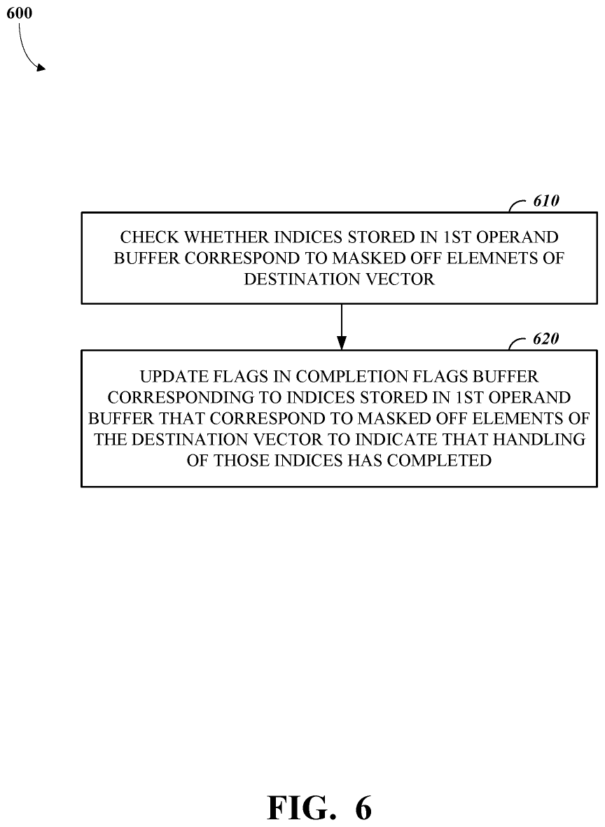

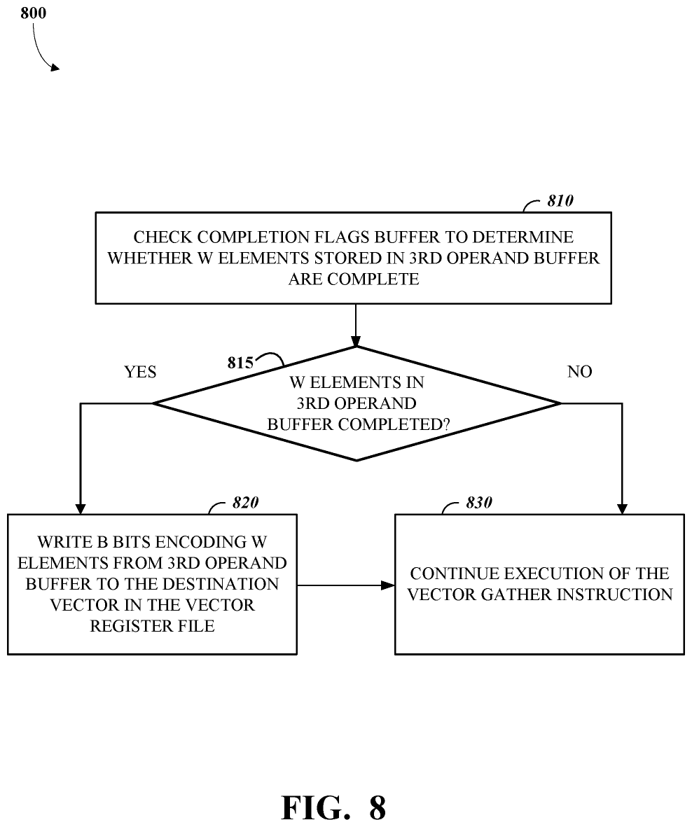

FIG. 1 is a block diagram of an example of an integrated circuit 110 for executing instructions including vector gather with a narrow datapath. For example, the integrated circuit 110 may be a processor, a microprocessor, a microcontroller, or an IP core. The integrated circuit 110 includes a processor core 120 configured to execute vector instructions that operate on vector arguments. In this example, the processor core 120 includes a vector register file 130 configured to store register values of an instruction set architecture; a datapath 132 with one or more ports of width b bits connecting the vector register file 130 to one or more execution units of the processor core 120; and a vector gather circuitry 140 configured to, responsive to a vector gather instruction identifying a vector of indices stored in the vector register file 130, a vector of source data stored in the vector register file 130, and a destination vector to be stored in the vector register file 130. The vector gather circuitry 140 includes a first operand buffer 150 connected to the vector register file 130 via the datapath 132; a second operand buffer 152 connected to the vector register file 130 via the datapath 132; a third operand buffer 154 connected to the vector register file 130 via the datapath 132; and a completion flags buffer 160. The vector gather circuitry 140 may be configured to opportunistically process multiple indices stored in the first operand buffer 150 that point to elements of data stored in the second operand buffer 152 in a single clock cycle, and track which indices in the first operand buffer 150 have been processed using the completion flags buffer 160. Processing multiple indices per clock cycle may improve performance of the processor core 120 for vector gather instructions. For example, the integrated circuit 110 may be used to implement the technique 400 of FIG. 4. For example, the integrated circuit 110 may be used to implement the technique 500 of FIG. 5. For example, the integrated circuit 110 may be used to implement the technique 600 of FIG. 6. For example, the integrated circuit 110 may be used to implement the technique 800 of FIG. 8.

The integrated circuit 110 includes a vector register file 130 configured to store register values of an instruction set architecture. In some implementations, the processor core 120 supports temporal processing of large vectors and the vector register file 130 supports register grouping to support vectors of varying lengths. For example, the processor core 120 may implement the RISC-V with vector extension and the vector register file 130 may be configured to store the register values of the RISC-V vector extension.

The integrated circuit 110 includes a datapath 132 with one or more ports of width b bits (e.g., 128 bits, 256 bits or 512 bits) connecting the vector register file to one or more execution units of the processor core 220. In some implementations, the width b of the ports may limit the speed at which data from large vectors may be processed to complete execution of a vector instruction.

The integrated circuit 110 includes a first operand buffer 150 connected to the vector register file 130 via the datapath 132. The first operand buffer 150 may be configured to store indices of a vector gather instruction that are read from a source register in the vector register file 130. The integrated circuit 110 includes a second operand buffer 152 connected to the vector register file 130 via the datapath 132. The second operand buffer 152 may be configured to store input data of a vector gather instruction that are read from a source register in the vector register file 130. The integrated circuit 110 includes a third operand buffer 154 connected to the vector register file 130 via the datapath 132. The third operand buffer 154 may be configured to store output data of a vector gather instruction that that will be written to a destination register in the vector register file 130.

The integrated circuit 110 includes a completion flags buffer 160. The completion flags buffer 160 may store flags (e.g., bits) corresponding to respective indices stored in the first operand buffer 150 indicating whether its respective index has been processed as needed. For example, completion of all the indices in the first operand buffer 150, as reflected in the completion flags buffer 160, may trigger output of data in the third operand buffer 154 to a destination register in the vector register file 130 and/or reading of a next set indices of length b bits from the vector register file 130 to the first operand buffer 150.

The integrated circuit 110 includes a vector gather circuitry 140 configured to, responsive to a vector gather instruction identifying a vector of indices stored in the vector register file 130, a vector of source data stored in the vector register file 130, and a destination vector to be stored in the vector register file 130. The vector gather circuitry 140 may be configured to read b bits of the vector of indices into the first operand buffer 150 via the datapath 132 and read b bits of the vector of source data into the second operand buffer 152 via the datapath 132. The b bits may encode w elements of the vector of source data, including an element indexed by a first index stored in the first operand buffer 150. In some implementations, the number of elements, w, depends on a vector element size, which may be a configurable parameter of the vector register file 130. The vector gather circuitry 140 may be configured to check whether other indices stored in the first operand buffer 150 point to elements of the vector of source data stored in the second operand buffer 152; during a single clock cycle, copy a plurality of elements stored in the second operand buffer 152 that are pointed to by indices stored in the first operand buffer 150 to the third operand buffer 154; and, during the single clock cycle, update flags in the completion flags buffer 160 corresponding to indices stored in the first operand buffer 150 that point to elements stored in the second operand buffer 152 to indicate that handling of those indices has completed. In some implementations, the vector gather circuitry 140 includes a w-element data crossbar, which may enable the transfer of elements from the first operand buffer 150 to various element positions within the third operand buffer 154.

In some implementations, the completion flags buffer 160 may also be updated based on conditions that render the retrieval of input data pointed to by an index unnecessary, such as the index taking a value in an invalid range or the output corresponding to the index being masked off in a masked vector gather instruction. For example, the vector gather circuitry 140 may be configured to check whether indices stored in the first operand buffer 150 are outside of a valid range for vector indices, and update flags in the completion flags buffer 160 corresponding to indices stored in the first operand buffer 150 that are outside of the valid range to indicate that handling of those indices has completed. The vector gather instruction may identify a register storing a mask. For example, the vector gather circuitry 140 may be configured to check whether indices stored in the first operand buffer 150 correspond to masked-off elements of the destination vector, and update flags in the completion flags buffer 160 corresponding to indices stored in the first operand buffer 150 that correspond to masked-off elements of the destination vector to indicate that handling of those indices has completed.

After processing the source data in the second operand buffer 152 that is pointed to by the indices in the first operand buffer 150, more source data may be read into the second operand buffer to enable processing of remaining indices. For example, the vector gather circuitry 140 may configured to read b bits of the vector of source data into the second operand buffer 152 via the datapath 132. The b bits may encode w elements of the vector source data, including an element indexed by a next index stored in the first operand buffer 150 that is indicated to be incomplete by a flag stored in the completion flag buffer 160.

Additional indices of the vector gather instruction may be read into the first operand buffer 150 as space becomes available. In some implementations, when the completion flag buffer 160 indicates all of the indices stored in the first operand buffer 150 have been processed as needed, a next b bits of indices may be read from the vector register file 130 into the first operand buffer 150. In some implementations, the first operand buffer 150 may be sized bigger than the width b of the port in the datapath 132 to enable reading additional indices from the vector register file 130 while an earlier set of indices is still being processed. The indices may be shifted within the larger first operand buffer 150 to keep as many of the earliest b bits worth of indices active in any given clock cycle as is feasible. For example, the first operand buffer 150 may be configured to store two times b bits, and the vector gather circuitry 140 may be configured to read a next b bits of the vector of indices into the first operand buffer 150 via the datapath 132; and shift out of the first operand buffer 150 indices that are indicated to have been completed by flags stored in the completion flags buffer 160.

Output data may be written to the vector register file 130 from the third operand buffer 154 when all the corresponding indices for a batch of output data have been processed. For example, the vector gather circuitry 140 may be configured to, responsive to the flags stored in the completion flag buffer 160 indicating that w elements stored in the third operand buffer 154 have been completed, write b bits encoding the w completed elements from the third operand buffer 154 to the destination vector via the datapath 132.

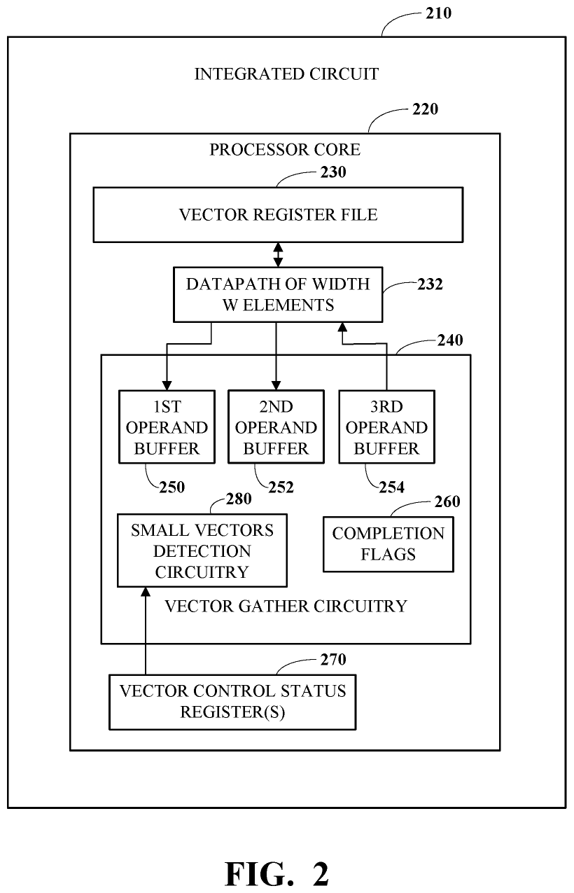

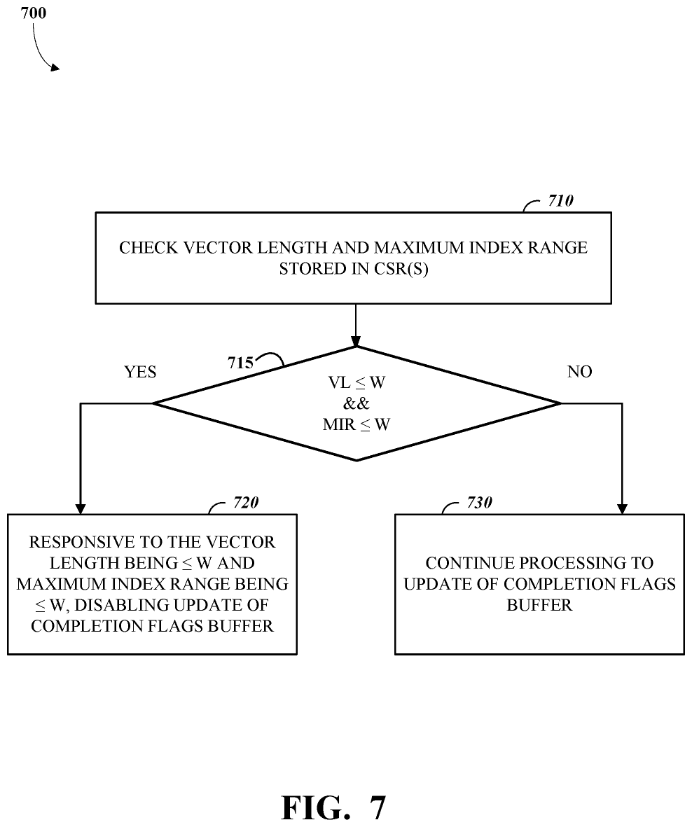

FIG. 2 is a block diagram of an example of an integrated circuit 210 for executing instructions including vector gather with a narrow datapath and dynamic small vector detection to improve performance for small vectors. For example, the integrated circuit 210 may be a processor, a microprocessor, a microcontroller, or an IP core. The integrated circuit 210 includes a processor core 220 configured to execute vector instructions that operate on vector arguments. In this example, the processor core 220 includes a vector register file 230 configured to store register values of an instruction set architecture; a datapath 232 with one or more ports of width b bits connecting the vector register file 230 to one or more execution units of the processor core 220; and a vector gather circuitry 240 configured to, responsive to a vector gather instruction identifying a vector of indices stored in the vector register file 230, a vector of source data stored in the vector register file 230, and a destination vector to be stored in the vector register file 230. The vector gather circuitry 240 includes a first operand buffer 250 connected to the vector register file 230 via the datapath 232; a second operand buffer 252 connected to the vector register file 230 via the datapath 232; a third operand buffer 254 connected to the vector register file 230 via the datapath 232; and a completion flags buffer 260. The vector gather circuitry 240 may be configured to opportunistically process multiple indices stored in the first operand buffer 250 that point to elements of data stored in the second operand buffer 252 in a single clock cycle, and track which indices in the first operand buffer 250 have been processed using the completion flags buffer 260. The processor core 220 includes one or more vector control status registers 270 that store configuration parameters for the vector register file 230, including one or more parameters indicating a vector length and one or more parameters indicating a maximum index range for vectors. In this example, the vector gather circuitry 240 includes a small vectors detection circuitry 280 that is configured to check a vector length and a maximum index range stored in the one or more vector control status registers 270 of the processor core 220; and, responsive to the vector length being less than or equal to w and the maximum index range being less than or equal to w, disable portions of the vector gather circuitry 240 that are configured to update the completion flags buffer 260. Processing multiple indices per clock cycle may improve performance of the processor core 220 for vector gather instructions. Processing all indices of a small vector in a single clock cycle may improve performance of the processor core 220 for vector gather instructions and enable faster chaining in and chaining out from vector gather instructions. For example, the integrated circuit 210 may be used to implement the technique 400 of FIG. 4. For example, the integrated circuit 210 may be used to implement the technique 500 of FIG. 5. For example, the integrated circuit 210 may be used to implement the technique 600 of FIG. 6. For example, the integrated circuit 210 may be used to implement the technique 700 of FIG. 7. For example, the integrated circuit 210 may be used to implement the technique 800 of FIG. 8.

The integrated circuit 210 includes a vector register file 230 configured to store register values of an instruction set architecture. In some implementations, the processor core 220 supports temporal processing of large vectors and the vector register file 230 supports register grouping to support vectors of varying lengths. For example, the processor core 220 may implement the RISC-V with vector extension and the vector register file 230 may be configured to store the register values of the RISC-V vector extension.

The integrated circuit 210 includes a datapath 232 with one or more ports of width b bits (e.g., 128 bits, 256 bits or 512 bits) connecting the vector register file to one or more execution units of the processor core 220. In some implementations, the width b of the ports may limit the speed at which data from large vectors may be processed to complete execution of a vector instruction.

The integrated circuit 210 includes a first operand buffer 250 connected to the vector register file 230 via the datapath 232. The first operand buffer 250 may be configured to store indices of a vector gather instruction that are read from a source register in the vector register file 230. The integrated circuit 210 includes a second operand buffer 252 connected to the vector register file 230 via the datapath 232. The second operand buffer 252 may be configured to store input data of a vector gather instruction that are read from a source register in the vector register file 230. The integrated circuit 210 includes a third operand buffer 254 connected to the vector register file 230 via the datapath 232. The third operand buffer 254 may be configured to store output data of a vector gather instruction that that will be written to a destination register in the vector register file 230.

The integrated circuit 210 includes a completion flags buffer 260. The completion flags buffer 260 may store flags (e.g., bits) corresponding to respective indices stored in the first operand buffer 250 indicating whether its respective index has been processed as needed. For example, completion of all the indices in the first operand buffer 250, as reflected in the completion flags buffer 260, may trigger output of data in the third operand buffer 254 to a destination register in the vector register file 230 and/or reading of a next set indices of length b bits from the vector register file 230 to the first operand buffer 250.

The integrated circuit 210 includes a vector gather circuitry 240 configured to, responsive to a vector gather instruction identifying a vector of indices stored in the vector register file 230, a vector of source data stored in the vector register file 230, and a destination vector to be stored in the vector register file 230. The vector gather circuitry 240 may be configured to read b bits of the vector of indices into the first operand buffer 250 via the datapath 232 and read b bits of the vector of source data into the second operand buffer 252 via the datapath 232. The b bits may encode w elements of the vector of source data, including an element indexed by a first index stored in the first operand buffer 250. In some implementations, the number of elements, w, depends on a vector element size, which may be a configurable parameter of the vector register file 230. The vector gather circuitry 240 may be configured to check whether other indices stored in the first operand buffer 250 point to elements of the vector of source data stored in the second operand buffer 252; during a single clock cycle, copy a plurality of elements stored in the second operand buffer 252 that are pointed to by indices stored in the first operand buffer 250 to the third operand buffer 254; and, during the single clock cycle, update flags in the completion flags buffer 260 corresponding to indices stored in the first operand buffer 250 that point to elements stored in the second operand buffer 252 to indicate that handling of those indices has completed. In some implementations, the vector gather circuitry 240 includes a w-element data crossbar, which may enable the transfer of elements from the first operand buffer 250 to various element positions within the third operand buffer 254.

In some implementations, the completion flags buffer 260 may also be updated based on conditions that render the retrieval of input data pointed to by an index unnecessary, such as the index taking a value in an invalid range or the output corresponding to the index being masked off in a masked vector gather instruction. For example, the vector gather circuitry 240 may be configured to check whether indices stored in the first operand buffer 250 are outside of a valid range for vector indices, and update flags in the completion flags buffer 260 corresponding to indices stored in the first operand buffer 250 that are outside of the valid range to indicate that handling of those indices has completed. The vector gather instruction may identify a register storing a mask. For example, the vector gather circuitry 240 may be configured to check whether indices stored in the first operand buffer 250 correspond to masked-off elements of the destination vector, and update flags in the completion flags buffer 260 corresponding to indices stored in the first operand buffer 250 that correspond to masked-off elements of the destination vector to indicate that handling of those indices has completed.

After processing the source data in the second operand buffer 252 that is pointed to by the indices in the first operand buffer 250, more source data may be read into the second operand buffer to enable processing of remaining indices. For example, the vector gather circuitry 240 may configured to read b bits of the vector of source data into the second operand buffer 252 via the datapath 232. The b bits may encode w elements of the vector source data, including an element indexed by a next index stored in the first operand buffer 250 that is indicated to be incomplete by a flag stored in the completion flag buffer 260.

Additional indices of the vector gather instruction may be read into the first operand buffer 250 as space becomes available. In some implementations, when the completion flag buffer 260 indicates all the indices stored in the first operand buffer 250 have been processed as needed, a next b bits of indices may be read from the vector register file 230 into the first operand buffer 250. In some implementations, the first operand buffer 250 may be sized bigger than the width b of the port in the datapath 232 to enable reading additional indices from the vector register file 230 while an earlier set of indices is still being processed. The indices may be shifted within the larger first operand buffer 250 to keep as many of the earliest b bits worth of indices active in any given clock cycle as is feasible. For example, the first operand buffer 250 may be configured to store two times b bits, and the vector gather circuitry 240 may be configured to read a next b bits of the vector of indices into the first operand buffer 250 via the datapath 232; and shift out of the first operand buffer 250 indices that are indicated to have been completed by flags stored in the completion flags buffer 260.

Output data may be written to the vector register file 230 from the third operand buffer 254 when all the corresponding indices for a batch of output data have been processed. For example, the vector gather circuitry 240 may be configured to, responsive to the flags stored in the completion flag buffer 260 indicating that w elements stored in the third operand buffer 254 have been completed, write b bits encoding the w completed elements from the third operand buffer 254 to the destination vector via the datapath 232.

The integrated circuit 210 includes a small vectors detection circuitry 280. The small vectors detection circuitry 280 may be configured to check a vector length and a maximum index range stored in the one or more control status registers 270 of the processor core 220; and, responsive to the vector length being less than or equal to w and the maximum index range being less than or equal to w, disable portions of the vector gather circuitry 240 that are configured to update the completion flags buffer 260. For example, disabling portions of the vector gather circuitry 240 may reduce power consumption when handling small vectors. The small vectors detection circuitry 280 may also be connected to a dispatch stage of pipeline (not shown in FIG. 2) of the processor core 220 and may enable faster chaining in and/or chaining out of a vector gather instruction with small vectors. Faster chaining may improve performance of the processor core 220.

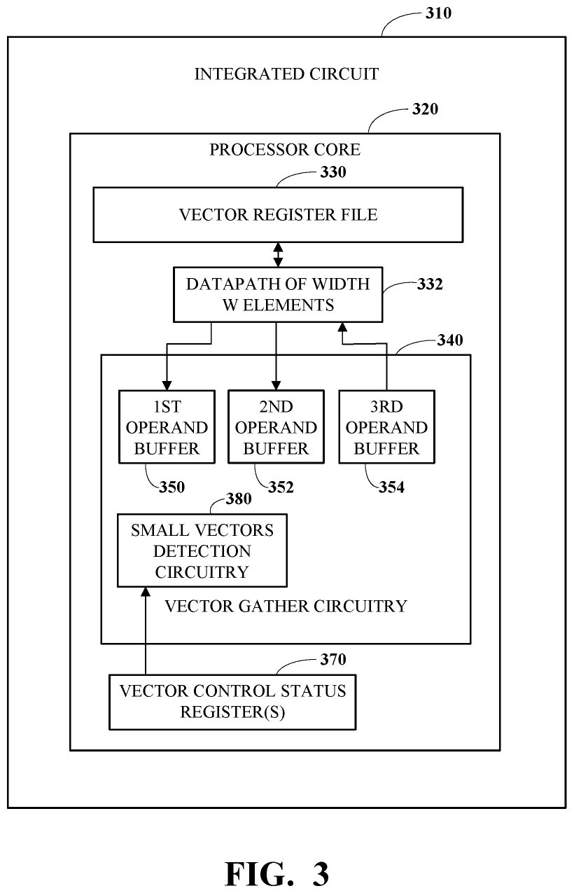

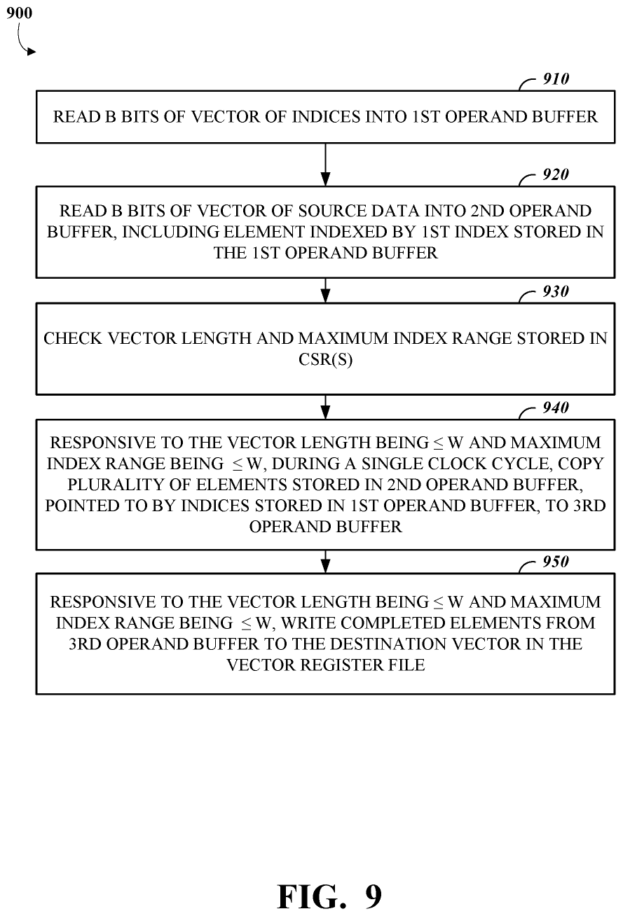

FIG. 3 is a block diagram of an example of an integrated circuit 310 for executing instructions including vector gather with a narrow datapath and dynamic small vector detection to improve performance for small vectors. For example, the integrated circuit 310 may be a processor, a microprocessor, a microcontroller, or an IP core. The integrated circuit 310 includes a processor core 320 configured to execute vector instructions that operate on vector arguments. In this example, the processor core 320 includes a vector register file 330 configured to store register values of an instruction set architecture; a datapath 332 with one or more ports of width b bits connecting the vector register file 330 to one or more execution units of the processor core 320; and a vector gather circuitry 340 configured to, responsive to a vector gather instruction identifying a vector of indices stored in the vector register file 330, a vector of source data stored in the vector register file 330, and a destination vector to be stored in the vector register file 330. The vector gather circuitry 340 includes a first operand buffer 350 connected to the vector register file 330 via the datapath 332; a second operand buffer 352 connected to the vector register file 330 via the datapath 332; a third operand buffer 354 connected to the vector register file 330 via the datapath 332. The vector gather circuitry 340 may be configured to process indices stored in the first operand buffer 350 that point to an element of data stored in the second operand buffer 352. The processor core 320 includes one or more vector control status registers 370 that store configuration parameters for the vector register file 330, including one or more parameters indicating a vector length and one or more parameters indicating a maximum index range for vectors. In this example, the vector gather circuitry 340 includes a small vectors detection circuitry 380 that is configured to check a vector length and a maximum index range stored in the one or more control status registers 370 of the processor core 220; and, responsive to the vector length being less than or equal to w and the maximum index range being less than or equal to w, during a single clock cycle, copy a plurality of elements stored in the second operand buffer 352 that are pointed to by indices stored in the first operand buffer 350 to the third operand buffer 354. Processing multiple indices per clock cycle may improve performance of the processor core 320 for vector gather instructions. Processing all indices of a small vector in a single clock cycle may improve performance of the processor core 320 for vector gather instructions and enable faster chaining in and chaining out from vector gather instructions. For example, the integrated circuit 310 may be used to implement the technique 900 of FIG. 9.

The integrated circuit 310 includes a vector register file 330 configured to store register values of an instruction set architecture. In some implementations, the processor core 320 supports temporal processing of large vectors and the vector register file 330 supports register grouping to support vectors of varying lengths. For example, the processor core 320 may implement the RISC-V with vector extension and the vector register file 330 may be configured to store the register values of the RISC-V vector extension.

The integrated circuit 310 includes a datapath 332 with one or more ports of width b bits (e.g., 128 bits, 256 bits or 512 bits) connecting the vector register file to one or more execution units of the processor core 320. In some implementations, the width b of the ports may limit the speed at which data from large vectors may be processed to complete execution of a vector instruction.

The integrated circuit 310 includes a first operand buffer 350 connected to the vector register file 330 via the datapath 332. The first operand buffer 350 may be configured to store indices of a vector gather instruction that are read from a source register in the vector register file 330. The integrated circuit 310 includes a second operand buffer 352 connected to the vector register file 330 via the datapath 332. The second operand buffer 352 may be configured to store input data of a vector gather instruction that are read from a source register in the vector register file 330. The integrated circuit 310 includes a third operand buffer 354 connected to the vector register file 330 via the datapath 332. The third operand buffer 354 may be configured to store output data of a vector gather instruction that that will be written to a destination register in the vector register file 330.

The integrated circuit 310 includes a vector gather circuitry 340 configured to, responsive to a vector gather instruction identifying a vector of indices stored in the vector register file 330, a vector of source data stored in the vector register file 330, and a destination vector to be stored in the vector register file 330. The vector gather circuitry 340 may be configured to read b bits of the vector of indices into the first operand buffer 350 via the datapath 332 and read b bits of the vector of source data into the second operand buffer 352 via the datapath 332. The b bits may encode w elements of the vector of source data, including an element indexed by a first index stored in the first operand buffer 350. In some implementations, the number of elements, w, depends on a vector element size, which may be a configurable parameter of the vector register file 330. The vector gather circuitry 340 may be configured to check the vector length and the maximum index range stored in the one or more control status registers 370 of the processor core 320; and, responsive to the vector length being less than or equal to w and the maximum index range being less than or equal to w, during a single clock cycle, copy a plurality of elements stored in the second operand buffer 352 that are pointed to by indices stored in the first operand buffer 350 to the third operand buffer 354. In some implementations, the vector gather circuitry 340 includes a w-element data crossbar, which may enable the transfer of elements from the first operand buffer 350 to various element positions within the third operand buffer 354.

In some implementations, the vector gather circuitry 340 may be configured to process one element per clock cycle if the vector length is greater than w or the maximum index range is greater than w, potentially reading b bits of data into the second operand buffer 352 to access each element of source data that will be stored in the third operand buffer 354 and written to the destination vector in the vector register file 330.

The vector gather circuitry 340 includes a small vectors detection circuitry 380. The small vectors detection circuitry 380 may be configured to check the vector length and the maximum index range stored in the one or more control status registers 370 of the processor core 320; and, responsive to the vector length being less than or equal to w and the maximum index range being less than or equal to w, during a single clock cycle, copy a plurality of elements stored in the second operand buffer 352 that are pointed to by indices stored in the first operand buffer 350 to the third operand buffer 354. In some implementations, the vector gather circuitry 340 is configured to, responsive to the vector length being less than or equal to w and the maximum index range being less than or equal to w, write completed elements from the third operand buffer 354 to the destination vector in the vector register file 330. The small vectors detection circuitry 380 may also be connected to a dispatch stage of pipeline (not shown in FIG. 3) of the processor core 320 and may enable faster chaining in and/or chaining out of a vector gather instruction with small vectors. Faster chaining may improve performance of the processor core 320.

FIG. 4 is a flow chart of an example of a technique 400 for vector gather with a narrow datapath. The technique 400 may be used to execute a vector gather instruction identifying a vector of indices stored in a vector register file (e.g., the vector register file 130), a vector of source data stored in the vector register file, and a destination vector to be stored in the vector register file. The technique 400 includes reading 410 b bits of the vector of indices into a first operand buffer; reading 420 b bits of the vector of source data into a second operand buffer, including an element indexed by a first index stored in the first operand buffer; checking 430 whether other indices stored in the first operand buffer point to elements of the vector of source data stored in the second operand buffer; during a single clock cycle, copying 440 a plurality of elements stored in the second operand buffer that are pointed to by indices stored in the first operand buffer to a third operand buffer; and, during the single clock cycle, updating 450 flags in a completion flags buffer corresponding to indices stored in the first operand buffer that point to elements stored in the second operand buffer to indicate that handling of those indices has completed. For example, the technique 400 may be implemented using the integrated circuit 110 of FIG. 1. For example, the technique 400 may be implemented using the integrated circuit 210 of FIG. 2.

The technique 400 includes reading 410 b bits of the vector of indices into a first operand buffer. For example, b may be the width of a port of a datapath (e.g., 128 bits, 256 bits or 512 bits). The technique 400 includes reading 420 b bits of the vector of source data into a second operand buffer. The b bits may encode w elements of the vector of source data, including an element indexed by a first index stored in the first operand buffer. In some implementations, the number of elements, w, depends on a vector element size, which may be a configurable parameter of the vector register that stores the arguments to the vector gather instruction. For example, where b is 256 bits and an element size for the vector is set to 32 bits, w would be 8.

The technique 400 includes checking 430 whether other indices stored in the first operand buffer point to elements of the vector of source data stored in the second operand buffer. For example, the w elements of source data read 420 in to the second operand buffer may happen to include more than one element that is indexed by one of the indices currently in the first operand buffer. Execution time of the vector gather instruction may be reduced by recognizing this opportunity when it occurs and exploiting it by processing multiple elements in a single clock cycle.

The technique 400 includes, during a single clock cycle, copying 440 a plurality of elements stored in the second operand buffer that are pointed to by indices stored in the first operand buffer to a third operand buffer. For example, an element of the source data in the second operand buffer pointed to by an index in the first operand buffer may be copied 440 to an element in the third operand buffer corresponding to the position of the index within the first operand buffer.

The technique 400 includes, during the single clock cycle, updating 450 flags in a completion flags buffer (e.g., the completion flags buffer 160) corresponding to indices stored in the first operand buffer that point to elements stored in the second operand buffer to indicate that handling of those indices has completed. Tracking which of the indices have been processed may enable processing of a variable number of elements per clock cycle when executing the vector gather instruction.

The technique 400 may continue until all indices of the vector of indices have been processed to complete execution of the vector gather instruction. At 455, if processing for all indices stored in the first operand buffer have not been completed, then the technique 400 includes reading 420 b bits of the vector of source data into the second operand buffer, wherein the b bits encode w elements of the vector source data, including an element indexed by a next index stored in the first operand buffer that is indicated to be incomplete by a flag stored in the completion flag buffer. At 455, if processing for all indices stored in the first operand buffer has been completed, but, at 465, all indices in the vector of indices have not been completed, then the technique 400 includes reading 410 the next b bits of the vector of indices into the first operand buffer. At 465, when all indices in the vector of indices have been completed, then execution of the vector gather instruction is completed 470.

In some implementations, the first operand buffer may be sized bigger than the width b of the port in the datapath to enable reading additional indices from vector register file while an earlier set of indices is still being processed. The indices may be shifted within the larger first operand buffer to keep as many of the earliest b bits worth of indices active in any given clock cycle as is feasible. For example, the first operand buffer may be configured to store two times b bits, and the technique 400 may include reading the next b bits of the vector of indices into the first operand buffer, and shifting out of the first operand buffer indices that are indicated to have been completed by flags stored in the completion flags buffer.

The technique 400 may be paired with the technique 800 of FIG. 8, which may be used in parallel to write output data from the third operand buffer to the destination vector in a vector register file when w elements (e.g., b bits of data) are ready.

In some implementations, the completion flags buffer may also be updated based on conditions that render the retrieval of input data pointed to by an index unnecessary, such as the index taking a value in an invalid range or the output corresponding to the index being masked off in a masked vector gather instruction. For example, the technique 400 may include updating the completion flags based on an index having a value outside of a valid range for indices using the technique 500 of FIG. 5. For example, the technique 400 may include updating the completion flags based on a mask for the vector gather instruction using the technique 600 of FIG. 6. In some implementations, one or more of these updates to the completion flags may occur during the single clock cycle that is used to copy 440 the plurality of elements pointed to by indices stored in the first operand buffer. In some implementations, one or more of these updates to the completion flags may occur during and earlier clock cycle before or in parallel with reading 420 of the b bits of source data into the second operand buffer.

The technique 400 may be modified to include detecting small vectors that fit in a single read through a port of the datapath, and exploiting these small vectors to simplify parallel processing of the indices and to enable faster chaining in and chaining out from the vector gather instruction being executed. For example, the technique 700 of FIG. 7 may be used before and/or during execution of the vector gather instruction to detect if the vector register storing the source data has number of elements less than or equal to w and a maximum index range less than or equal to w, to obviate the need to track completion of individual indices.

FIG. 5 is a flow chart of an example of a technique 500 for tracking completion of indices that are outside a valid range. The technique 500 includes checking 510 whether indices stored in the first operand buffer are outside of a valid range for vector indices; and updating 520 flags in the completion flags buffer corresponding to indices stored in the first operand buffer that are outside of the valid range to indicate that handling of those indices has completed. In some implementations, an element in the third operand buffer is set to a default value (e.g., set to zero) when its corresponding index stored in the first operand buffer is outside of the valid range. For example, the technique 500 may be implemented using the integrated circuit 110 of FIG. 1. For example, the technique 500 may be implemented using the integrated circuit 210 of FIG. 2.

FIG. 6 is a flow chart of an example of a technique 600 for tracking completion of indices for a masked vector gather instruction. The vector gather instruction may identify a register storing a mask. For example, the mask may control output of the vector gather instruction by masking off individual elements. It may be unnecessary to access source data corresponding to masked-off elements. The technique 600 includes checking 610 whether indices stored in the first operand buffer correspond to masked-off elements of the destination vector; and updating 620 flags in the completion flags buffer corresponding to indices stored in the first operand buffer that correspond to masked-off elements of the destination vector to indicate that handling of those indices has completed. For example, the technique 600 may be implemented using the integrated circuit 110 of FIG. 1. For example, the technique 600 may be implemented using the integrated circuit 210 of FIG. 2.

FIG. 7 is a flow chart of an example of a technique 700 for simplifying vector gather completion when a variable vector length is small. In the special case where a vector is small enough to fit through a port of the datapath in a single clock cycle, the processing of indices may be performed in parallel in a relatively simple way based on a guarantee that all valid indices will point an element stored in the second operand buffer at the same time. The technique 700 includes checking 710 a vector length and a maximum index range stored in one or more control status registers (e.g., the one or more vector control status registers 270) of the processor core. At 715, if the vector length is less than or equal to w and the maximum index range is less than or equal to w, then, the technique 700 includes, responsive to the vector length being less than or equal to w and the maximum index range being less than or equal to w, disabling 720 update of the completion flags buffer. For example, disabling the circuitry that tracks completion of the indices may reduce power consumption. At 715, if the vector length is greater than w or the maximum index range is greater than w, then, processing will continue to update 730 the completion flags buffer to track completion of the indices stored in the first operand buffer. Equivalently, the vector length in bytes may be compared to w times the element size or b. The detection of a small vector may also be used in a dispatch stage of a pipeline of the processor core and may enable faster chaining in and/or chaining out of a vector gather instruction with small vectors. Faster chaining may improve performance of the processor core. In some implementations, the vector size may be checked 710 before dispatch of the vector gather instruction to an execution unit of the processor core to facilitate chaining. For example, the technique 700 may be implemented using the integrated circuit 210 of FIG. 2.

FIG. 8 is a flow chart of an example of a technique 800 for outputting data of a vector gather instruction to a destination register. The technique 800 includes checking 810 a completion flags buffer (e.g., the completion flags buffer 160) to determine whether w elements stored in the third operand buffer are complete and ready to be output to a vector register file (e.g., the vector register file 130). At 815, if the w elements in the third operand buffer are completed, then the technique 800 includes, responsive to the flags stored in the completion flag buffer indicating that w elements stored in the third operand buffer have been completed, writing 820 b bits encoding the w completed elements from the third operand buffer to the destination vector in the vector register file. The technique 800 includes continuing 830 execution of the vector gather instruction (e.g., using the technique 400 of FIG. 4) to either finish updating the elements of the third operand buffer or to start updating the next set of w elements to be stored in the destination register. For example, the technique 800 may be implemented using the integrated circuit 110 of FIG. 1. For example, the technique 800 may be implemented using the integrated circuit 210 of FIG. 2.

FIG. 9 is a flow chart of an example of a technique 900 for vector gather with a narrow datapath and variable vector length. The technique 900 may be used to execute a vector gather instruction identifying a vector of indices stored in a vector register file (e.g., the vector register file 330), a vector of source data stored in the vector register file, and a destination vector to be stored in the vector register file. The technique 900 includes reading 910 b bits of the vector of indices into a first operand buffer; reading 920 b bits of the vector of source data into a second operand buffer, wherein the b bits encode w elements of the vector of source data; checking 930 a vector length and a maximum index range stored in one or more control status registers of a processor core; responsive to the vector length being less than or equal to w and the maximum index range being less than or equal to w, during a single clock cycle, copying 940 a plurality of elements stored in the second operand buffer that are pointed to by indices stored in the first operand buffer to a third operand buffer; and, responsive to the vector length being less than or equal to w and the maximum index range being less than or equal to w, writing 950 completed elements from the third operand buffer to the destination vector. For example, the technique 900 may be implemented using the integrated circuit 210 of FIG. 2. For example, the technique 900 may be implemented using the integrated circuit 310 of FIG. 3.

The technique 900 includes reading 910 b bits of the vector of indices into a first operand buffer. For example, b may be the width of a port of a datapath (e.g., 128 bits, 256 bits or 512 bits). The technique 900 includes reading 920 b bits of the vector of source data into a second operand buffer. The b bits may encode w elements of the vector of source data. In some implementations, the number of elements, w, depends on a vector element size, which may be a configurable parameter of the vector register that stores the arguments to the vector gather instruction. For example, where b is 128 bits and an element size for the vector is set to 8 bits, w would be 16.

The technique 900 includes checking 930 a vector length and a maximum index range stored in one or more control status registers (e.g., the one or more vector control status registers 370) of a processor core. Execution of vector gather instruction may be simplified when a variable vector length is small enough that whole vectors fit through a port of a datapath in a single clock cycle. The simplification may be based on a guarantee that all valid indices will point an element stored in the second operand buffer at the same time. Vector processor configuration parameters may be checked 930 to detect when a vector length is small enough.

The technique 900 includes, responsive to the vector length being less than or equal to w and the maximum index range being less than or equal to w, during a single clock cycle, copying 940 a plurality of elements stored in the second operand buffer that are pointed to by indices stored in the first operand buffer to a third operand buffer.

The technique 900 includes, responsive to the vector length being less than or equal to w and the maximum index range being less than or equal to w, writing 950 completed elements from the third operand buffer to the destination vector. For example, all w elements stored in the third operand buffer may be written 950 to the destination register. In some implementations, a subset of the w elements stored in the third operand buffer are written 950 to the destination register, while a subset of the w elements stored in the third operand buffer are masked off based on a mask register identified by the vector gather instruction.

The detection of a small vector may also be used in a dispatch stage of a pipeline of the processor core and may enable faster chaining in and/or chaining out of a vector gather instruction with small vectors. Faster chaining may improve performance of the processor core. In some implementations, the vector size may be checked 930 before dispatch of the vector gather instruction to an execution unit of the processor core to facilitate chaining.

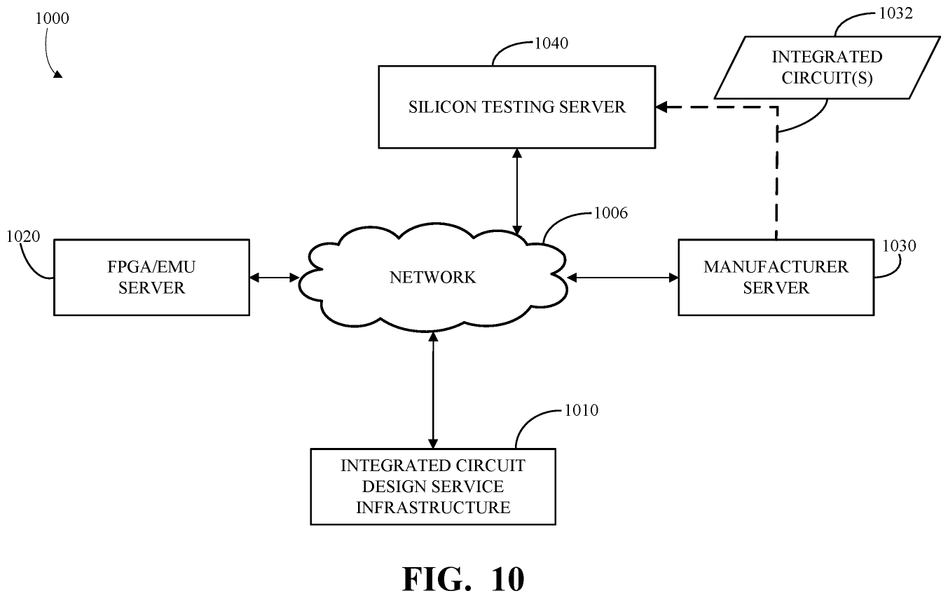

FIG. 10 is block diagram of an example of a system 1000 for generation and manufacture of integrated circuits. The system 1000 includes a network 1006, an integrated circuit design service infrastructure 1010, a field programmable gate array (FPGA)/emulator server 1020, and a manufacturer server 1030. For example, a user may utilize a web client or a scripting API client to command the integrated circuit design service infrastructure 1010 to automatically generate an integrated circuit design based a set of design parameter values selected by the user for one or more template integrated circuit designs. In some implementations, the integrated circuit design service infrastructure 1010 may be configured to generate an integrated circuit design that includes the circuitry shown and described in FIG. 1, 2, or 3.

The integrated circuit design service infrastructure 1010 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high-level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 1010 may invoke (e.g., via network communications over the network 1006) testing of the resulting design that is performed by the FPGA/emulation server 1020 that is running one or more FPGAs or other types of hardware or software emulators. For example, the integrated circuit design service infrastructure 1010 may invoke a test using a field programmable gate array, programmed based on a field programmable gate array emulation data structure, to obtain an emulation result. The field programmable gate array may be operating on the FPGA/emulation server 1020, which may be a cloud server. Test results may be returned by the FPGA/emulation server 1020 to the integrated circuit design service infrastructure 1010 and relayed in a useful format to the user (e.g., via a web client or a scripting API client).

The integrated circuit design service infrastructure 1010 may also facilitate the manufacture of integrated circuits using the integrated circuit design in a manufacturing facility associated with the manufacturer server 1030. In some implementations, a physical design specification (e.g., a graphic data system (GDS) file, such as a GDS II file) based on a physical design data structure for the integrated circuit is transmitted to the manufacturer server 1030 to invoke manufacturing of the integrated circuit (e.g., using manufacturing equipment of the associated manufacturer). For example, the manufacturer server 1030 may host a foundry tape out website that is configured to receive physical design specifications (e.g., as a GDSII file or an OASIS file) to schedule or otherwise facilitate fabrication of integrated circuits. In some implementations, the integrated circuit design service infrastructure 1010 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 1010 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 1030 may fabricate and/or test integrated circuits based on the integrated circuit design. For example, the associated manufacturer (e.g., a foundry) may perform optical proximity correction (OPC) and similar post-tapeout/pre-production processing, fabricate the integrated circuit(s) 1032, update the integrated circuit design service infrastructure 1010 (e.g., via communications with a controller or a web application server) periodically or asynchronously on the status of the manufacturing process, perform appropriate testing (e.g., wafer testing), and send to packaging house for packaging. A packaging house may receive the finished wafers or dice from the manufacturer and test materials and update the integrated circuit design service infrastructure 1010 on the status of the packaging and delivery process periodically or asynchronously. In some implementations, status updates may be relayed to the user when the user checks in using the web interface and/or the controller might email the user that updates are available.

In some implementations, the resulting integrated circuits 1032 (e.g., physical chips) are delivered (e.g., via mail) to a silicon testing service provider associated with a silicon testing server 1040. In some implementations, the resulting integrated circuits 1032 (e.g., physical chips) are installed in a system controlled by silicon testing server 1040 (e.g., a cloud server) making them quickly accessible to be run and tested remotely using network communications to control the operation of the integrated circuits 1032. For example, a login to the silicon testing server 1040 controlling a manufactured integrated circuits 1032 may be sent to the integrated circuit design service infrastructure 1010 and relayed to a user (e.g., via a web client). For example, the integrated circuit design service infrastructure 1010 may control testing of one or more integrated circuits 1032, which may be structured based on an RTL data structure.

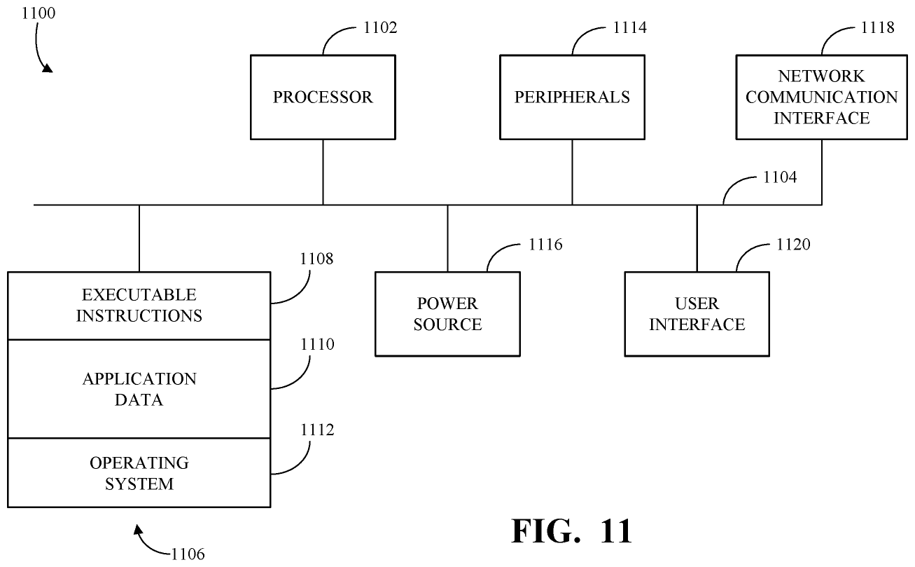

FIG. 11 is block diagram of an example of a system 1100 for facilitating generation of integrated circuits, for facilitating generation of a circuit representation for an integrated circuit, and/or for programming or manufacturing an integrated circuit. The system 1100 is an example of an internal configuration of a computing device. The system 1100 may be used to implement the integrated circuit design service infrastructure 1010, and/or to generate a file that generates a circuit representation of an integrated circuit design including the circuitry shown and described in FIG. 1, 2, or 3. The system 1100 can include components or units, such as a processor 1102, a bus 1104, a memory 1106, peripherals 1114, a power source 1116, a network communication interface 1118, a user interface 1120, other suitable components, or a combination thereof.

The processor 1102 can be a central processing unit (CPU), such as a microprocessor, and can include single or multiple processors having single or multiple processing cores. Alternatively, the processor 1102 can include another type of device, or multiple devices, now existing or hereafter developed, capable of manipulating or processing information. For example, the processor 1102 can include multiple processors interconnected in any manner, including hardwired or networked, including wirelessly networked. In some implementations, the operations of the processor 1102 can be distributed across multiple physical devices or units that can be coupled directly or across a local area or other suitable type of network. In some implementations, the processor 1102 can include a cache, or cache memory, for local storage of operating data or instructions.

The memory 1106 can include volatile memory, non-volatile memory, or a combination thereof. For example, the memory 1106 can include volatile memory, such as one or more DRAM modules such as double data rate (DDR) synchronous dynamic random access memory (SDRAM), and non-volatile memory, such as a disk drive, a solid state drive, flash memory, Phase-Change Memory (PCM), or any form of non-volatile memory capable of persistent electronic information storage, such as in the absence of an active power supply. The memory 1106 can include another type of device, or multiple devices, now existing or hereafter developed, capable of storing data or instructions for processing by the processor 1102. The processor 1102 can access or manipulate data in the memory 1106 via the bus 1104. Although shown as a single block in FIG. 11, the memory 1106 can be implemented as multiple units. For example, a system 1100 can include volatile memory, such as RAM, and persistent memory, such as a hard drive or other storage.

The memory 1106 can include executable instructions 1108, data, such as application data 1110, an operating system 1112, or a combination thereof, for immediate access by the processor 1102. The executable instructions 1108 can include, for example, one or more application programs, which can be loaded or copied, in whole or in part, from non-volatile memory to volatile memory to be executed by the processor 1102. The executable instructions 1108 can be organized into programmable modules or algorithms, functional programs, codes, code segments, or combinations thereof to perform various functions described herein. For example, the executable instructions 1108 can include instructions executable by the processor 1102 to cause the system 1100 to automatically, in response to a command, generate an integrated circuit design and associated test results based on a design parameters data structure. The application data 1110 can include, for example, user files, database catalogs or dictionaries, configuration information or functional programs, such as a web browser, a web server, a database server, or a combination thereof. The operating system 1112 can be, for example, Microsoft Windows®, macOS®, or Linux®, an operating system for a small device, such as a smartphone or tablet device; or an operating system for a large device, such as a mainframe computer. The memory 1106 can comprise one or more devices and can utilize one or more types of storage, such as solid state or magnetic storage.

The peripherals 1114 can be coupled to the processor 1102 via the bus 1104. The peripherals 1114 can be sensors or detectors, or devices containing any number of sensors or detectors, which can monitor the system 1100 itself or the environment around the system 1100. For example, a system 1100 can contain a temperature sensor for measuring temperatures of components of the system 1100, such as the processor 1102. Other sensors or detectors can be used with the system 1100, as can be contemplated. In some implementations, the power source 1116 can be a battery, and the system 1100 can operate independently of an external power distribution system. Any of the components of the system 1100, such as the peripherals 1114 or the power source 1116, can communicate with the processor 1102 via the bus 1104.

The network communication interface 1118 can also be coupled to the processor 1102 via the bus 1104. In some implementations, the network communication interface 1118 can comprise one or more transceivers. The network communication interface 1118 can, for example, provide a connection or link to a network, such as the network 1006 shown in FIG. 10, via a network interface, which can be a wired network interface, such as Ethernet, or a wireless network interface. For example, the system 1100 can communicate with other devices via the network communication interface 1118 and the network interface using one or more network protocols, such as Ethernet, transmission control protocol (TCP), Internet protocol (IP), power line communication (PLC), wireless fidelity (Wi-Fi), infrared, general packet radio service (GPRS), global system for mobile communications (GSM), code division multiple access (CDMA), or other suitable protocols.

A user interface 1120 can include a display; a positional input device, such as a mouse, touchpad, touchscreen, or the like; a keyboard; or other suitable human or machine interface devices. The user interface 1120 can be coupled to the processor 1102 via the bus 1104. Other interface devices that permit a user to program or otherwise use the system 1100 can be provided in addition to or as an alternative to a display. In some implementations, the user interface 1120 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 1114. The operations of the processor 1102 can be distributed across multiple clients or servers, which can be coupled directly or across a local area or other suitable type of network. The memory 1106 can be distributed across multiple clients or servers, such as network-based memory or memory in multiple clients or servers performing the operations of clients or servers. Although depicted here as a single bus, the bus 1104 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

In a first aspect, the subject matter described in this specification can be embodied in integrated circuit for executing instructions that includes a vector register file configured to store register values of an instruction set architecture; a datapath with one or more ports of width b bits connecting the vector register file to one or more execution units of a processor core; a first operand buffer connected to the vector register file via the datapath; a second operand buffer connected to the vector register file via the datapath; a third operand buffer connected to the vector register file via the datapath; a completion flags buffer; and a vector gather circuitry configured to, responsive to a vector gather instruction identifying a vector of indices stored in the vector register file, a vector of source data stored in the vector register file, and a destination vector to be stored in the vector register file: read b bits of the vector of indices into the first operand buffer via the datapath; read b bits of the vector of source data into the second operand buffer via the datapath, wherein the b bits encode w elements of the vector of source data, including an element indexed by a first index stored in the first operand buffer; check whether other indices stored in the first operand buffer point to elements of the vector of source data stored in the second operand buffer; during a single clock cycle, copy a plurality of elements stored in the second operand buffer that are pointed to by indices stored in the first operand buffer to the third operand buffer; and, during the single clock cycle, update flags in the completion flags buffer corresponding to indices stored in the first operand buffer that point to elements stored in the second operand buffer to indicate that handling of those indices has completed.

In the first aspect, the vector gather circuitry may be configured to check whether indices stored in the first operand buffer are outside of a valid range for vector indices; and update flags in the completion flags buffer corresponding to indices stored in the first operand buffer that are outside of the valid range to indicate that handling of those indices has completed. For example, the vector gather instruction may identify a register storing a mask. In the first aspect, the vector gather circuitry may be configured to check whether indices stored in the first operand buffer correspond to masked-off elements of the destination vector; and update flags in the completion flags buffer corresponding to indices stored in the first operand buffer that correspond to masked-off elements of the destination vector to indicate that handling of those indices has completed. In the first aspect, the integrated circuit may include a small vectors detection circuitry configured to check a vector length and a maximum index range stored in one or more control status registers of the processor core; and, responsive to the vector length being less than or equal to w and the maximum index range being less than or equal to w, disable portions of the vector gather circuitry that are configured to update the completion flags buffer. In the first aspect, the vector gather circuitry may be configured to read b bits of the vector of source data into the second operand buffer via the datapath, wherein the b bits encode w elements of the vector source data, including an element indexed by a next index stored in the first operand buffer that is indicated to be incomplete by a flag stored in the completion flag buffer. In the first aspect, the first operand buffer may be configured to store two times b bits, and the vector gather circuitry may be configured to read a next b bits of the vector of indices into the first operand buffer via the datapath; and shift out of the first operand buffer indices that are indicated to have been completed by flags stored in the completion flags buffer. In the first aspect, the vector gather circuitry may be configured to, responsive to the flags stored in the completion flag buffer indicating that w elements stored in the third operand buffer have been completed, write b bits encoding the w completed elements from the third operand buffer to the destination vector via the datapath. In the first aspect, the vector gather circuitry may include a w-element data crossbar.

In a second aspect, the subject matter described in this specification can be embodied in methods for executing a vector gather instruction identifying a vector of indices stored in a vector register file, a vector of source data stored in the vector register file, and a destination vector to be stored in the vector register file that include reading b bits of the vector of indices into a first operand buffer; reading b bits of the vector of source data into a second operand buffer, wherein the b bits encode w elements of the vector of source data, including an element indexed by a first index stored in the first operand buffer; checking whether other indices stored in the first operand buffer point to elements of the vector of source data stored in the second operand buffer; during a single clock cycle, copying a plurality of elements stored in the second operand buffer that are pointed to by indices stored in the first operand buffer to a third operand buffer; and, during the single clock cycle, updating flags in a completion flags buffer corresponding to indices stored in the first operand buffer that point to elements stored in the second operand buffer to indicate that handling of those indices has completed.

In the second aspect, the methods may include checking whether indices stored in the first operand buffer are outside of a valid range for vector indices; and updating flags in the completion flags buffer corresponding to indices stored in the first operand buffer that are outside of the valid range to indicate that handling of those indices has completed. In the second aspect, the vector gather instruction may identify a register storing a mask and the methods may include checking whether indices stored in the first operand buffer correspond to masked-off elements of the destination vector; and updating flags in the completion flags buffer corresponding to indices stored in the first operand buffer that correspond to masked-off elements of the destination vector to indicate that handling of those indices has completed. In the second aspect, the methods may include checking a vector length and a maximum index range stored in one or more control status registers of the processor core; and, responsive to the vector length being less than or equal to w and the maximum index range being less than or equal to w, disabling update of the completion flags buffer. In the second aspect, the methods may include reading b bits of the vector of source data into the second operand buffer, wherein the b bits encode w elements of the vector source data, including an element indexed by a next index stored in the first operand buffer that is indicated to be incomplete by a flag stored in the completion flag buffer. In the second aspect, the first operand buffer is configured to store two times b bits and the methods may include reading a next b bits of the vector of indices into the first operand buffer; and shifting out of the first operand buffer indices that are indicated to have been completed by flags stored in the completion flags buffer. In the second aspect, the methods may include, responsive to the flags stored in the completion flag buffer indicating that w elements stored in the third operand buffer have been completed, writing b bits encoding the w completed elements from the third operand buffer to the destination vector.

In a third aspect, the subject matter described in this specification can be embodied in integrated circuit for executing instructions that includes a vector register file configured to store register values of an instruction set architecture; a datapath with one or more ports of width b bits connecting the vector register file to one or more execution units of a processor core; a first operand buffer connected to the vector register file via the datapath; a second operand buffer connected to the vector register file via the datapath; a third operand buffer connected to the vector register file via the datapath; one or more control status registers configured to store a vector length and a maximum index range; and a vector gather circuitry configured to, responsive to a vector gather instruction identifying a vector of indices stored in the vector register file, a vector of source data stored in the vector register file, and a destination vector to be stored in the vector register file: read b bits of the vector of indices into the first operand buffer via the datapath; read b bits of the vector of source data into the second operand buffer via the datapath, wherein the b bits encode w elements of the vector of source data; check the vector length and the maximum index range stored in the one or more control status registers of the processor core; and, responsive to the vector length being less than or equal to w and the maximum index range being less than or equal to w, during a single clock cycle, copy a plurality of elements stored in the second operand buffer that are pointed to by indices stored in the first operand buffer to the third operand buffer.

In the third aspect, the vector gather circuitry may be configured to, responsive to the vector length being less than or equal to w and the maximum index range being less than or equal to w, write completed elements from the third operand buffer to the destination vector. In the third aspect, the vector gather circuitry may include a w-element data crossbar.

In a fourth aspect, the subject matter described in this specification can be embodied in methods for executing a vector gather instruction identifying a vector of indices stored in a vector register file, a vector of source data stored in the vector register file, and a destination vector to be stored in the vector register file that include reading b bits of the vector of indices into a first operand buffer; reading b bits of the vector of source data into a second operand buffer, wherein the b bits encode w elements of the vector of source data; checking a vector length and a maximum index range stored in one or more control status registers of a processor core; and responsive to the vector length being less than or equal to w and the maximum index range being less than or equal to w, during a single clock cycle, copying a plurality of elements stored in the second operand buffer that are pointed to by indices stored in the first operand buffer to a third operand buffer.

In the fourth aspect, the methods may include, responsive to the vector length being less than or equal to w and the maximum index range being less than or equal to w, writing completed elements from the third operand buffer to the destination vector.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An integrated circuit comprising:
a vector register file configured to store register values of an instruction set architecture;
a datapath with one or more ports of width b bits connecting the vector register file to one or more execution units of a processor core;
a first operand buffer connected to the vector register file via the datapath;
a second operand buffer connected to the vector register file via the datapath;
a third operand buffer connected to the vector register file via the datapath;
a completion flags buffer; and
a vector gather circuitry configured to, responsive to a vector gather instruction identifying a vector of indices stored in the vector register file, a vector of source data stored in the vector register file, and a destination vector to be stored in the vector register file:
read b bits of the vector of indices into the first operand buffer via the datapath;
read b bits of the vector of source data into the second operand buffer via the datapath, wherein the b bits encode w elements of the vector of source data, including an element indexed by a first index stored in the first operand buffer;
check whether other indices stored in the first operand buffer point to elements of the vector of source data stored in the second operand buffer;
during a single clock cycle, copy a plurality of elements stored in the second operand buffer that are pointed to by indices stored in the first operand buffer to the third operand buffer; and
during the single clock cycle, update flags in the completion flags buffer corresponding to indices stored in the first operand buffer that point to elements stored in the second operand buffer to indicate that handling of those indices has completed.

2. The integrated circuit of claim 1, in which the vector gather circuitry is configured to:
check whether indices stored in the first operand buffer are outside of a valid range for vector indices; and
update flags in the completion flags buffer corresponding to indices stored in the first operand buffer that are outside of the valid range to indicate that handling of those indices has completed.

3. The integrated circuit of claim 1, in which the vector gather instruction identifies a register storing a mask, and in which the vector gather circuitry is configured to:
check whether indices stored in the first operand buffer correspond to masked-off elements of the destination vector; and
update flags in the completion flags buffer corresponding to indices stored in the first operand buffer that correspond to masked-off elements of the destination vector to indicate that handling of those indices has completed.

4. The integrated circuit of claim 1, comprising a small vectors detection circuitry is configured to:
check a vector length and a maximum index range stored in one or more control status registers of the processor core; and
responsive to the vector length being less than or equal to w and the maximum index range being less than or equal to w, disable portions of the vector gather circuitry that are configured to update the completion flags buffer.

5. The integrated circuit of claim 1, in which the vector gather circuitry is configured to:
read b bits of the vector of source data into the second operand buffer via the datapath, wherein the b bits encode w elements of the vector source data, including an element indexed by a next index stored in the first operand buffer that is indicated to be incomplete by a flag stored in the completion flag buffer.

6. The integrated circuit of claim 5, in which first operand buffer is configured to store two times b bits, and the vector gather circuitry is configured to:
read a next b bits of the vector of indices into the first operand buffer via the datapath; and
shift out of the first operand buffer indices that are indicated to have been completed by flags stored in the completion flags buffer.

7. The integrated circuit of claim 1, in which the vector gather circuitry is configured to:
responsive to the flags stored in the completion flag buffer indicating that w elements stored in the third operand buffer have been completed, write b bits encoding the w completed elements from the third operand buffer to the destination vector via the datapath.

8. The integrated circuit of claim 1, in which the vector gather circuitry includes a w-element data crossbar.

9. A method for executing a vector gather instruction identifying a vector of indices stored in a vector register file, a vector of source data stored in the vector register file, and a destination vector to be stored in the vector register file, comprising:
reading b bits of the vector of indices into a first operand buffer;
reading b bits of the vector of source data into a second operand buffer, wherein the b bits encode w elements of the vector of source data, including an element indexed by a first index stored in the first operand buffer;
checking whether other indices stored in the first operand buffer point to elements of the vector of source data stored in the second operand buffer;
during a single clock cycle, copying a plurality of elements stored in the second operand buffer that are pointed to by indices stored in the first operand buffer to a third operand buffer; and
during the single clock cycle, updating flags in a completion flags buffer corresponding to indices stored in the first operand buffer that point to elements stored in the second operand buffer to indicate that handling of those indices has completed.

10. The method of claim 9, comprising:
checking whether indices stored in the first operand buffer are outside of a valid range for vector indices; and
updating flags in the completion flags buffer corresponding to indices stored in the first operand buffer that are outside of the valid range to indicate that handling of those indices has completed.

11. The method of claim 9, in which the vector gather instruction identifies a register storing a mask, comprising:
checking whether indices stored in the first operand buffer correspond to masked-off elements of the destination vector; and
updating flags in the completion flags buffer corresponding to indices stored in the first operand buffer that correspond to masked-off elements of the destination vector to indicate that handling of those indices has completed.

12. The method of claim 9, comprising:
checking a vector length and a maximum index range stored in one or more control status registers of the processor core; and
responsive to the vector length being less than or equal to w and the maximum index range being less than or equal to w, disabling update of the completion flags buffer.

13. The method of claim 9, comprising:
reading b bits of the vector of source data into the second operand buffer, wherein the b bits encode w elements of the vector source data, including an element indexed by a next index stored in the first operand buffer that is indicated to be incomplete by a flag stored in the completion flag buffer.

14. The method of claim 13, in which the first operand buffer is configured to store two times b bits, comprising:
reading a next b bits of the vector of indices into the first operand buffer; and
shifting out of the first operand buffer indices that are indicated to have been completed by flags stored in the completion flags buffer.

15. The method of claim 9, comprising:
responsive to the flags stored in the completion flag buffer indicating that w elements stored in the third operand buffer have been completed, writing b bits encoding the w completed elements from the third operand buffer to the destination vector.

16. An integrated circuit comprising:
a vector register file configured to store register values of an instruction set architecture;
a datapath with one or more ports of width b bits connecting the vector register file to one or more execution units of a processor core;
a first operand buffer connected to the vector register file via the datapath;
a second operand buffer connected to the vector register file via the datapath;
a third operand buffer connected to the vector register file via the datapath;
one or more control status registers configured to store a vector length and a maximum index range; and
a vector gather circuitry configured to, responsive to a vector gather instruction identifying a vector of indices stored in the vector register file, a vector of source data stored in the vector register file, and a destination vector to be stored in the vector register file:
read b bits of the vector of indices into the first operand buffer via the datapath;
read b bits of the vector of source data into the second operand buffer via the datapath, wherein the b bits encode w elements of the vector of source data;
check the vector length and the maximum index range stored in the one or more control status registers of the processor core; and
responsive to the vector length being less than or equal to w and the maximum index range being less than or equal to w, during a single clock cycle, copy a plurality of elements stored in the second operand buffer that are pointed to by indices stored in the first operand buffer to the third operand buffer.

17. The integrated circuit of claim 16, in which the vector gather circuitry is configured to:
responsive to the vector length being less than or equal to w and the maximum index range being less than or equal to w, write completed elements from the third operand buffer to the destination vector.

18. The integrated circuit of claim 16, in which the vector gather circuitry includes a w-element data crossbar.
